(19) United States
(12) Patent Application Publication
(10) Pub. No.: US 2009/0195933 A1
(43) Pub. Date: Aug. 6, 2009

(54) HEAD ASSEMBLY

(75) Inventors: Takuma Kido, Kawasaki (JP); Atsushi Koga, Kawasaki (JP); Satoshi Emoto, Kawasaki (JP); Kenrou Yamamoto, Kawasaki (JP); Takeshi Ohwe, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/361,233

(22) Filed: Jan. 28, 2009

(30) Foreign Application Priority Data
Jan. 31, 2008 (JP) 2008-021106

(51) Int. Cl. G11B 5/48

(52) U.S. Cl. 360/240; G9B/5.147

(57) ABSTRACT

A head assembly for writing or reading information to or from a recording medium. The head assembly includes a suspension having an electrode pad; a mounting member placed on the suspension; a head mounted on the mounting member and having an electrode, for writing or reading information; and a first bonding member made of a hot-melt adhesive and fixing the electrode to the electrode pad.

### CROSS-REFERENCE TO RELATED APPLICATIONS

This application is based upon and claims the benefit of priority of the prior Japanese Patent Application No. 2008-021106, filed on Jan. 31, 2008, the entire contents of which are incorporated herein by reference.

### FIELD

The embodiments discussed herein are related to a head assembly for reading/writing information from/on a recording medium.

### BACKGROUND

In recent years, magnetic disk devices have been mounted on not only conventional computers including personal computers, but also on home information appliances or music players. Magnetic disk devices mounted on these appliances are preferably inexpensive. In order to supply products at low costs, it is important to enhance the yield rate in manufacturing and reduce the cost of spoilage.

The magnetic disk device incorporates a head element including an electromagnetic transducer for writing information on the magnetic disk or reading information recorded from the magnetic disk. In general, characteristics of the head element are evaluated in advance when manufacturing the magnetic disk. Typically, in a state where the magnetic head having the head element and a suspension for supporting the magnetic head on the magnetic disk have been assembled together, that is, in a state where they are assembled into a head gimbal assembly (HGA), characteristics of the head element are evaluated. As a result of characteristic evaluation, an HGA that has been determined to be a conforming product, which meets requirements for head element characteristics is built into the magnetic disk device. On the other hand, an HGA that has been determined to be a nonconforming product, which does not meet requirements for head element characteristics is discarded.

The problem here, however, is that the suspension is also discarded together with the magnetic head having the head element determined to be a nonconforming product. Usually, the magnetic head having the head element and the suspension are fixed by an adhesive such as a thermosetting resin. Therefore, once the magnetic head has been fixed to the suspension, it is difficult to dismount the magnetic head from the suspension without destructing or deforming the suspension.

The spoilage of many of HGAs that are determined to be nonconforming products by characteristic evaluations of head elements is attributable to head elements themselves such as output drops of heads or electrostatic discharge (ESD) destructions thereof, and rarely attributable to suspensions supporting magnetic heads. Nevertheless, together with magnetic heads having head elements determined to be the nonconforming products in characteristic evaluation of head elements, many suspensions in which there is nothing wrong with their function are also discarded, which incurs significantly high spoilage cost. Now that the adoption of techniques such as a micro-actuator and a piezo-censor is supposed to raise the unit cost of the suspension, the discarding of suspensions together with nonconforming head elements is causing an increasingly serious problem.

As methods for solving this problem, the following addresses are being carried out.

1) HT (Head Test; Electromagnetic Conversion Characteristic Test with Respect to a Magnetic Head Alone)

The magnetic head HT is a method for making a test with respect to a magnetic head alone before the magnetic head is mounted on a suspension. In the head HT, the test is performed with the head attached to a jig (pseudo suspension). Only a magnetic head that is a conforming product is mounted on a real suspension. For this purpose, there is a need for a head mounting/dismounting mechanism capable of mounting and then dismounting a head on/from the jig. As a head mounting mechanism with respect to a jig, a mechanical mounting mechanism such as a clamp structure by a leaf spring has been proposed. However, when the magnetic head is mounted on the jig by such a mechanical mounting mechanism, the magnetic head may be subjected to minute deformation (crown). Such being the case, as a mounting/dismounting mechanism that dismountably mounts the magnetic head on the suspension, a mechanism has been proposed in which a magnetic head slider is mounted on the suspension via a plate member (for example, refer to Japanese Laid-open Patent Publication No. 11-312373). In this mechanism, the plate member is fixed in advance to a gimbal, and the magnetic head slider is fixed to the plate member by soldering. By melting the solder, the magnetic head slider can be dismounted from the plate member.

2) Magnetic Head Replacement

Magnetic head replacement is a method wherein a magnetic head is dismounted from an HGA that has been determined to be a nonconforming product by a magnetic head test, and a new magnetic head is mounted on the HGA, whereby the suspension is reused. As an example of this method, a method has been proposed wherein a flexure functioning as a suspension is cut off in the vicinity of a portion where the flexure is mounted on a load beam, and after both the magnetic head and the flexure have been dismounted, a flexure having a new magnetic head is again mounted on the load beam (for example, refer to Japanese Laid-open Patent Publication No. 2004-79034).

However, the above-described methods involve the following problems.

1) In order to implement the magnetic head HT, when the magnetic head slider is fixed to the plate member using solder as proposed in the above-described Japanese Laid-open Patent Publication No. 11-312373, forces due to contraction when the solder solidifies and contraction by temperature change are applied to the magnetic head slider, so that there occurs a possibility that the magnetic head slider may deform. Once the magnetic head slider has deformed, a problem is caused that the flying characteristic of the magnetic head slider is affected or the position accuracy of the magnetic head is deteriorated. Furthermore, the position or posture of the magnetic head differs between during the magnetic head HT and after the magnetic head and the suspension are assembled into an HGA (i.e. a state of being used under a drive). This incurs a troubling issue that the flying amount of the magnetic head do not conform between during test (magnetic head HT) and during device usage, to thereby cause a deviation in head characteristic therebetween.

2) In the magnetic head replacement, it is necessary to dismount the magnetic head slider from the real HGA (suspension). One method that is currently being tried is a method wherein, using a structure such that the gimbal and the magnetic head are fixed by solder bonding at two places, i.e. at a flow-in end (front end) and a flow-out end (back end), and then the magnetic head is dismounted by melting the solder. In this method, since both edges (flow-in edge and flow-out edge) of the magnetic head slider are fixed by solder bonding, there is a problem that an occurrence of contraction of solder due to environmental change may deform the magnetic head.

### SUMMARY

According to an aspect of the invention, a head assembly for writing or reading information to or from a recording medium includes a suspension including an electrode pad; a mounting member placed on the suspension; a head mounted on the mounting member and including an electrode, for writing or reading information; and a first bonding member made of a hot-melt adhesive, fixing the electrode to the electrode pad.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a plan view of a magnetic head assembly to which an embodiment is applied;

FIG. 2 is a plan view of a portion of a head assembly according to a first embodiment;

FIG. 3 is a side view of the portion of the head assembly illustrated in FIG. 2;

FIGS. 4A and 4B are diagrams of a head-intermediate plate assembly illustrated in FIG. 3, wherein FIG. 4A is a plan view thereof and FIG. 4B is a side view thereof;

FIG. 5 is a perspective view of a stack structure composed of a gimbal, an intermediate plate, and a head illustrated in FIG. 2;

FIG. 6 is a perspective view of the stack structure composed of the gimbal, the intermediate plate, and the head illustrated in FIG. 2;

FIG. 7 is a perspective view of the stack structure composed of the gimbal, the intermediate plate, and the head illustrated in FIG. 2;

FIG. 8 is a sectional view of a solder bonded portion of a front side electrode pad of the intermediate plate;

FIG. 9 is a plan view of a portion of a head assembly according to a second embodiment;

FIG. 10 is a side view of a portion where the head illustrated in FIG. 9 is fixed;

FIGS. 11A and 11B are diagrams of a head-intermediate plate assembly illustrated in FIG. 9; wherein FIG. 11A is a plan view thereof and FIG. 11B is a side view thereof;

FIG. 12 is a perspective view of a stack structure composed of the gimbal, the intermediate plate, and the head illustrated in FIG. 9;

FIG. 13 is a perspective view of the stack structure composed of the gimbal, the intermediate plate, and the head illustrated in FIG. 9;

FIG. 14 is a perspective view of the stack structure composed of the gimbal, the intermediate plate, and the head illustrated in FIG. 9;

FIGS. 15A and 15B are diagrams of a head-intermediate plate assembly composed of the intermediate plate having slits and the head, wherein FIG. 15A is a plan view thereof and FIG. 15B is a side view thereof;

FIG. 16 is a plan view of a portion of an head assembly having an intermediate plate of which bonding pads are disposed at positions corresponding to a side surface of the head;

FIG. 17 is a side view of a portion where the head illustrated in FIG. 16 is fixed.

FIGS. 18A and 18B are diagrams of the head-intermediate plate assembly illustrated in FIG. 16, wherein FIG. 18A is a plan view thereof and FIG. 18B is a side view thereof;

FIG. 19 is a perspective view of a stack structure composed of the gimbal, the intermediate plate, and the head illustrated in FIG. 16;

FIG. 20 is a perspective view of the stack structure composed of the gimbal, the intermediate plate, and the head illustrated in FIG. 16;

FIG. 21 is a perspective view of the stack structure composed of the gimbal, the intermediate plate, and the head illustrated in FIG. 16;

FIGS. 22A and 22B are diagrams of a head-intermediate plate assembly used in a magnetic head assembly according to a third embodiment, wherein FIG. 22A is a plan view thereof and FIG. 22B is a side view thereof;

FIG. 23 is a perspective view of a stack structure composed of the gimbal, the intermediate plate, and the head illustrated in FIGS. 22A and 22B;

FIG. 24 is a perspective view of the stack structure composed of the gimbal, the intermediate plate, and the head illustrated in FIG. 22;

FIG. 25 is a perspective view of the stack structure composed of the gimbal, the intermediate plate, and the head illustrated in FIG. 22;

FIG. 26 is a perspective view of the head-intermediate plate assembly in FIG. 25, as viewed from the back side;

FIG. 27 is a plan view of a portion of the magnetic head assembly when a modification of solder-bonding is applied to the magnetic head assembly according to the second embodiment;

FIG. 28 is a side view of a portion where the head illustrated in FIG. 27 is fixed;

FIGS. 29A, 29B, and 29C are diagrams of the head-intermediate plate assembly illustrated in FIG. 27, wherein FIG. 29A is a plan view thereof, FIG. 29B is a side view thereof, and FIG. 29C is a front view thereof;

FIG. 30 is a perspective view of a portion where electrode pads of the intermediate plate, electrodes of the head, and electrode pads of the gimbal are solder bonded together;

FIG. 31 is a plan view of a portion of the magnetic head assembly when another modification of solder-bonding is applied to the magnetic head assembly according to the second embodiment;

FIG. 32 is a side view of a portion where a head illustrated in FIG. 31 is fixed;

FIGS. 33A, 33B, and 33C are diagrams of the head-intermediate plate assembly illustrated in FIG. 31, wherein FIG. 33A is a plan view thereof, FIG. 33B is a side view thereof, and FIG. 33C is a front view thereof; and

FIG. 34 is a plan view of an intermediate plate having tear electrode pads.

### DESCRIPTION OF EMBODIMENTS

Hereinafter, embodiments according to the present invention will be described with respect to appended drawings.

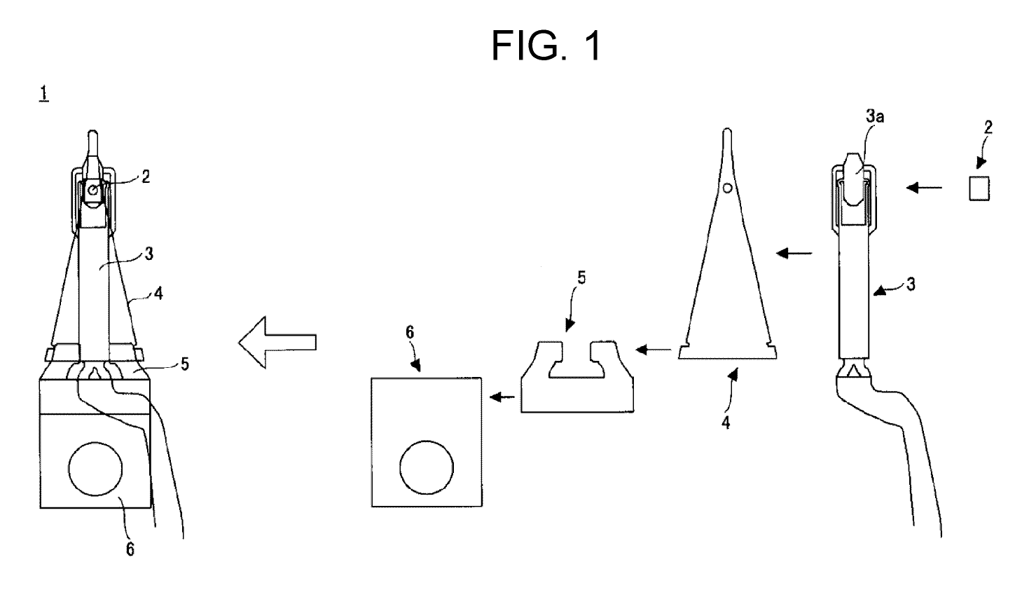

Now, the entirety of a head assembly to which the present invention is applied is explained with reference to FIG. 1. The head assembly illustrated in FIG. 1 is a magnetic head assembly (HGA; head-gimbal assembly) 1 used in a magnetic disk device. The magnetic head assembly 1 is a component for supporting a magnetic head slider 2 mounting a magnetic head. Hereinafter, the magnetic head slider 2 is simply referred to as a head 2.

The head 2 is mounted on a gimbal 3a of a flexible flexure 3. The flexure 3 is provided with wiring, to which electrodes of the attached head 2 are connected. Thereby, the head 2 and external circuitry are electrically connected to each other. The flexure 3 equipped with the head 2 is mounted on a load beam 4. Furthermore, a root part of the load beam 4 is attached to hinge plate 5. The hinge plate 5 is fixed to a base plate 6. The base plate 6 is attached to an actuator provided in the magnetic disk device, whereby the magnetic head assembly 1 is configured to be movable along the radial direction of the magnetic disk.

As describe above, the magnetic head assembly 1 is an assembly including the head 2, the flexure 3, the load beam 4, the hinge plate 5, and the base plate 6, and hence it is a comparatively expensive component. Therefore, when an electrical test of the head 2 is made in a state of the magnetic head assembly 1 and the head 2 has been found to be a nonconforming product, discarding of the magnetic head assembly 1 in its entirety would cause a high spoilage cost. With this being the situation, if the head 2 can be easily dismounted from the gimbal 3a of the flexure 3, it is possible to replace only the nonconforming head 2 with a new head 2, and utilize other components without discarding them.

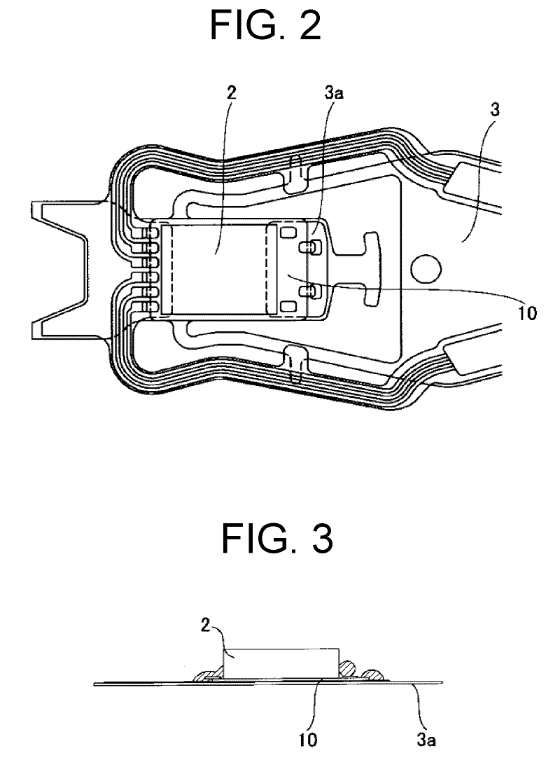

Now, a head assembly according to a first embodiment is described. FIG. 2 is a plan view of a portion of the head assembly according to the first embodiment. FIG. 2 shows only one portion in which the head 2 of the head assembly is mounted. FIG. 3 is a side view of a portion where the head assembly illustrated in FIG. 2 is mounted.

In the present embodiment, the head 2 is mounted on the gimbal 3a of the flexure via an intermediate plate 10 (a mounting member) serving as the mounting/dismounting member. That is, as illustrated in FIG. 2, the intermediate plate 10 is disposed on the gimbal 3a, and the head 2 is disposed on the intermediate plate 10, with the intermediate plate 10 and the head 2 fixed to the gimbal 3a.

Here, in the present embodiment, the head 2 is fixed to the intermediate plate 10 using hot-melt adhesive such as solder. Because solder is used to electrically connect the electrodes 2a of the head 2, the solder for use in electrical connection is also used for fixing the head, in the present embodiment.

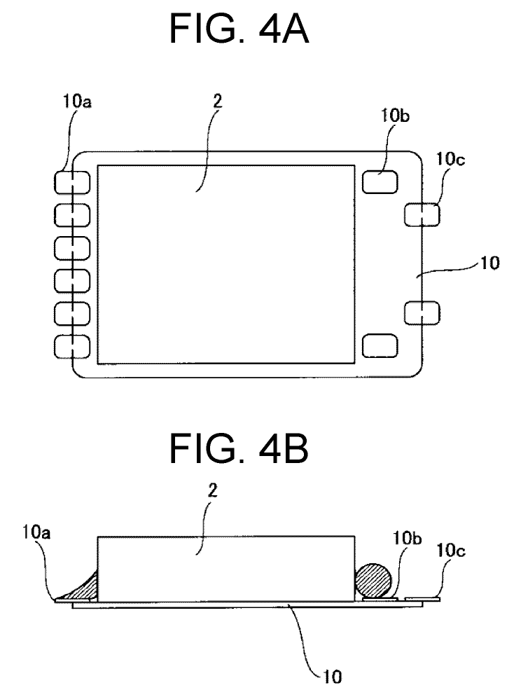

FIG. 4A is plan views showing how the head 2 is mounted on the intermediate plate 10, and FIG. 4B is a side view of the head 2 and the intermediate plate 10 illustrated in FIG. 4A. The head 2 is first mounted on the intermediate plate 10. On the intermediate plate 10, there are provided electrode pads 10a serving as relay electrode pads at positions corresponding to the electrodes 2a arranged in the front side-surface 2b of the head 2.

On the back side of the intermediate plate 10, bonding pads 10b for fixing the head are provided. The bonding pads 10b are not intended for electrical connection, but are used solely for the purpose of fixing the head 2. That is, on the back side-surface 2c of the head 2, there are provided bonding pads (not illustrated) made of a solder-bondable metal such as cupper, as in the case of the electrodes 2a. By solder bonding these bonding pads and the bonding pads 10b of the intermediate plate 10, the back side-surface side of the head 2 is fixed to the intermediate plate 10. The bonding pads on the back side-face of the head 2 are not pads having an electrical function, but are pads intended for providing solder-bondable portions on the back side-surface of the head 2. However, because these pads are made of a similar metal to the electrode 2a on the front side-surface 2b of the head 2, it may be referred to as “electrodes” for the sake of convenience. Likewise, the bonding pads 10b of the intermediate plate 10 are not portions having an electrical function, but pads intended for providing solder-bondable portions to the intermediate plate 10. However, because these pads are made of a similar metal to the electrode pads 10a on the front side, it may be referred to as “electrode pads” for the sake of convenience. That is, these bonding pads without an electrical function each perform a function as a solder bonding portion.

In the present embodiment, the head-intermediate plate assembly illustrated in FIGS. 4A and 4B is mounted on the gimbal 3a of the flexure 3 into a state illustrated in FIG. 2. The mounting of the head-intermediate plate assembly is performed by soldering. As described above, in the vicinity of the front end of the intermediate plate 10, i.e. adjacently to the front side-surface 2b of the head 2, electrode pads 10a serving as relay electrode pads are provided at positions corresponding to the electrodes 2a of the head 2. Furthermore, in the vicinity of the back end of the intermediate plate 10, i.e. adjacently to the back side-surface of the head 2, electrode pads 10c are provided. By solder bonding the electrode pads 10a and the bonding pads 10c, respectively, to the electrode pads and the bonding pads on the gimbal 3a, the intermediate plate 10 can be fixed to the gimbal 3a. That is, by solder bonding the electrode pads 10a and the bonding pads 10c, respectively, to the electrode pads and the bonding pad on the gimbal 3a, the electrodes 2a can be mounted on the flexure 3 via the intermediate plate 10 serving as the mounting/dismounting member.

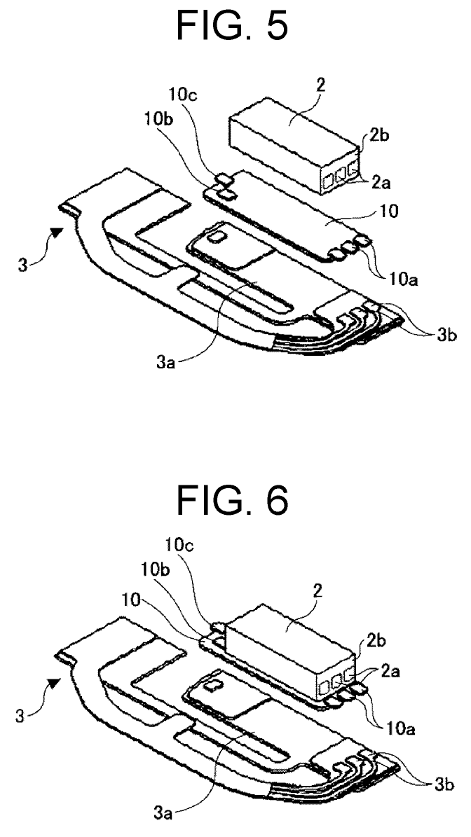

FIGS. 5 to 7 are perspective views of a stack structure composed of the gimbal 3a, the intermediate plate 10, and head 2. Here, FIGS. 5 to 7 each show only one half side of the flexure 3 divided by the center line thereof.

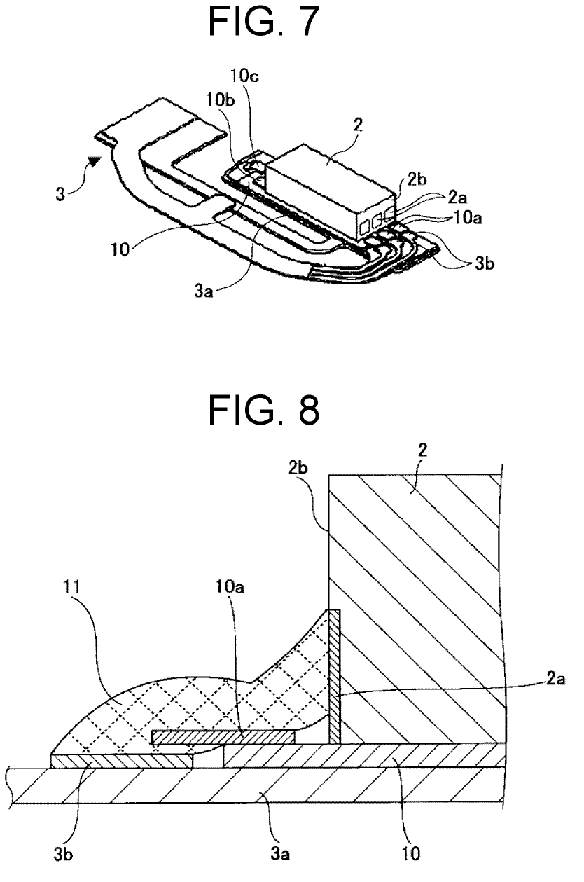

FIG. 5 illustrates a state in which the gimbal 3a, the intermediate plate 10, and the head 2 are separated from one another. First, as illustrated in FIG. 6, the head 2 and the intermediate plate 10 are solder bonded together to thereby form a head-intermediate plate assembly (in FIG. 6, solder is omitted from illustration). Then, as illustrated in FIG. 7, the head-intermediate plate assembly is solder bonded to the gimbal 3a and fixed thereto (in FIG. 7, solder is omitted from illustration).

Here, with reference to FIG. 8, description is made of solder bonding of the electrode pad 10a on the front side of the intermediate plate 10. FIG. 8 is a sectional diagram of a solder bonded portion of the electrode pad 10a on the front side of the intermediate plate 10. The electrode pad 10a has a portion protruded forward relative to the front end of the intermediate plate 10. When the head-intermediate plate assembly is disposed on the gimbal 3a of the flexure 3, the protruded portion of the electrode pads 10a come in a state of running on the electrode pads 3b of the on the gimbal 3a. In this state, the electrode pad 10a is to be solder bonded to the electrode pad 3b. Here, because the electrode pad 10a has previously been solder bonded to the electrode 2a of the head 2, this solder is melted by heat occurring when the electrode pad 3b is solder bonded, and fuses together with the solder for being bonded to the electrode pad 3b to thereby form a united solder. Upon solidification of the united solder, as illustrated in FIG. 8, a bonding structure is formed in which the electrode pad 3b on the gimbal 3a, the electrode pad 10a of the intermediate plate 10, the electrode 2a of the head 2 are bonded together by a solder lump 11 as a bonding member. Thus, in this bonding fixation structure, the electrode 2a of the head 2 is also bonded to the electrode pad 3b of the gimbal 3a by the solder 11.

On the other hand, the bonding pad 10c on the back end side of the intermediate plate 10 is also solder bonded to the bonding pad on the gimbal 3a and fixed thereto. As a result, the head-intermediate plate assembly including the head 2 is fixed to the gimbal 3a of the flexure 3 by solder bonding.

According to the above-described bonding fixation structure, the head 2 is mounted on the gimbal 3a via the intermediate plate 10 and fixed thereto. Although the electrodes 2a on the front side of the head 2 are directly fixed to the gimbal 3a by the solder 11, regarding the back side of the head 2, only the bonding pad 10b portion is fixed to the intermediate plate 10. Even if a thermal expansion coefficient of the head 2 and that of the gimbal 3a are much different from each other, by forming the intermediate plate 10 with a thin film such as polyimide, it is possible to accommodate the difference in thermal expansion coefficient therebetween to thereby prevent deformation of the head 2.

That is, on its front side, the head 2 has been bonded to the gimbal 3a by the solder 11, but the back side thereof has been bonded only to the intermediate plate 10. Hence, the head 2 is in a state where only a half side thereof is fixed to the gimbal 3a, portions other than the fixed portion (front side) of the head 2 are not constrained by the gimbal 3a. Therefore, even if the thermal expansion coefficient of the head 2 and that of the gimbal 3a are much different from each other, stress due to difference between thermal expansion coefficients would not occur in the head 2 or the gimbal 3a.

Furthermore, by forming the intermediate plate 10 serving as the mounting/dismounting member by a material having a Young's modulus lower than that of materials of the head 2 and the flexure 3 (e.g., stainless steel), and having a linear expansion coefficient higher than materials of the head 2 and the flexure 3, influences of thermal contraction of solder can be accommodated by the intermediate plate 10. That is, even if the head 2 is pulled along a direction in which the head 2 elongates due to the thermal contraction, a thermal contraction amount of solder would be offset by an expansion amount of the intermediate plate 10 because the intermediate plate 10 expands more than the head 2 and the gimbal 3a. As a result, a large stress would not occurs in the head 2, thereby allowing prevention of the head 2 from deformation.

According to the present embodiment, since the intermediate plate 10 having the head 2 (head-intermediate plate assembly) is fixed to the flexure 3 by solder bonding, melting the solder fixing the intermediate plate allows the head 2 to be easily dismounted from the gimbal 3a together with the intermediate plate 10. Therefore, when, after the head has been built in the head assemble, a test is made and the head 2 is determined to be a nonconforming product, there is no need to discard the head assembly in its entirety. That is, by dismounting both the nonconforming head 2 and the intermediate plate 10, and fixing a new head 2 to the gimbal 3a together with the intermediate plate 10, it is possible to reuse the flexure 3, the load beam 4, the hinge plate 5, and the base plate 6. This allows a reduction in spoilage cost of the head assembly.

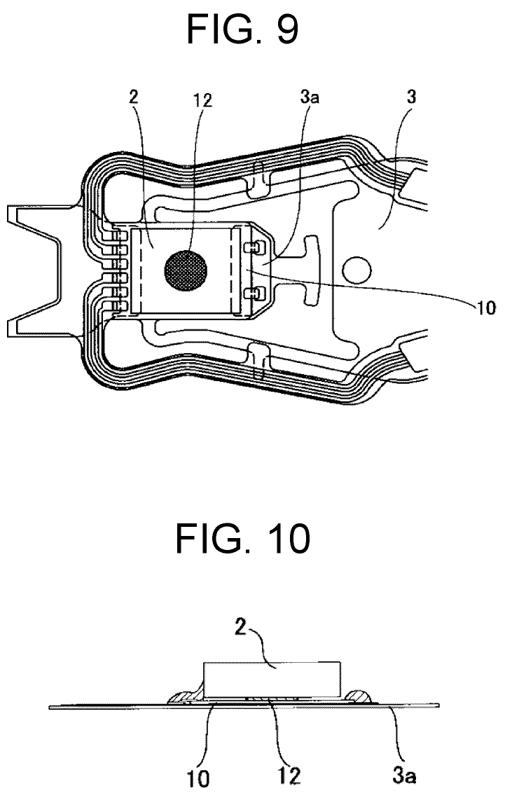

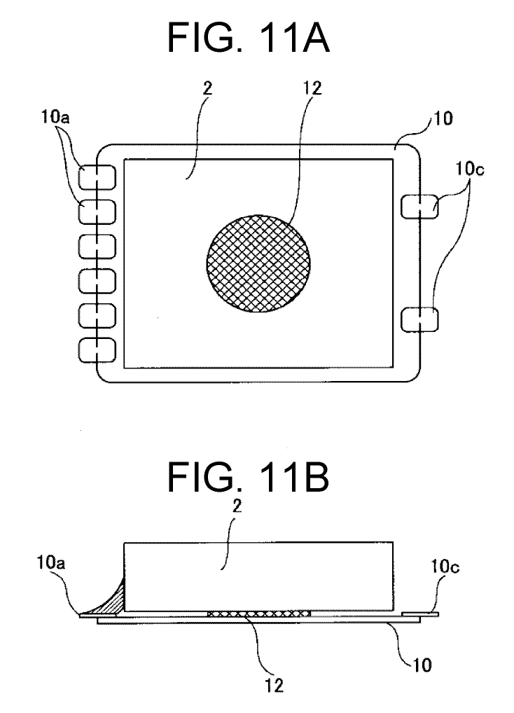

Next, a head assembly according to a second embodiment is described. FIG. 9 is a plan view of a portion of a head assembly according to the second embodiment. FIG. 10 is a side view of a portion where a head illustrated in FIG. 9 is fixed. FIGS. 11A and 11B are diagrams of a head-intermediate plate assembly illustrated in FIG. 9, wherein FIG. 11A is a plan view thereof and FIG. 11B is a side view thereof.

In the second embodiment, the bonding between the head 2 and the intermediate plate 10 is performed by an adhesive. As the adhesive, it is preferable to use an ultraviolet curable adhesive (UV curable adhesive). In FIG. 9, a round region illustrated in the center of the head 2 indicates a region where an adhesive 12 is provided. In actuality, although the adhesive 12 is not appeared on the head 2 because it is placed between the head 2 and the intermediate plate 10, FIG. 9 shows the adhesive 12 in a perspective manner for the sake of convenience.

Because the intermediate plate 10 according to the present embodiment is bonded to the head 2 by the adhesive 12, there is no need for the bonding pad 10b for bonding the back side-surface of the head 2. This eliminates the need for a region where the bonding pad 10b is to be arranged, and allows the intermediate plate 10 to be reduced correspondingly. As a result, the mounting region of the head 2 in the gimbal 3a can be reduced.

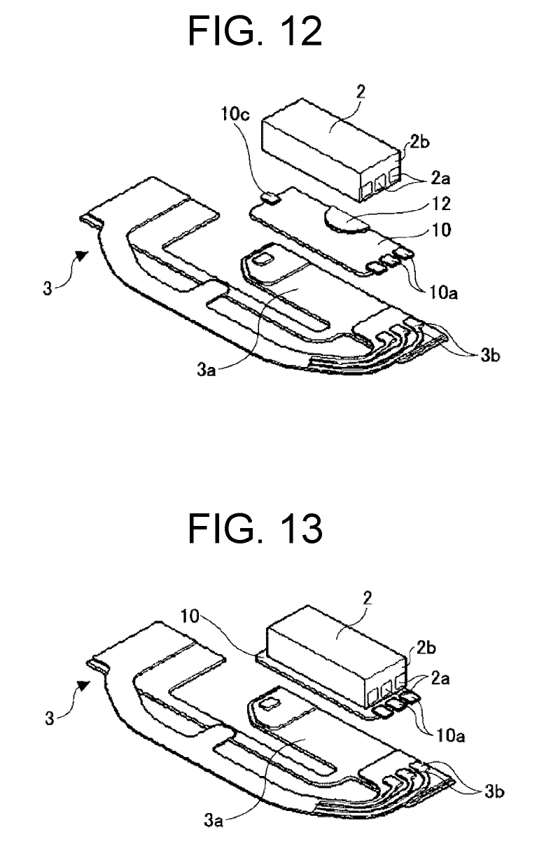

FIGS. 12 to 14 are perspective view of a stack structure composed of the gimbal 3a, the intermediate plate 10, and the head 2. Here, FIGS. 12 to 14 each show only one half side of the flexure 3 divided by the center line thereof.

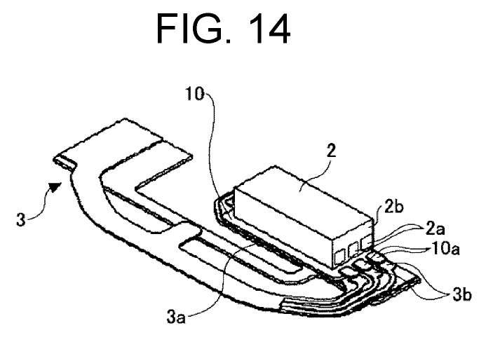

FIG. 12 shows how the gimbal 3a, the intermediate plate 10, and the head 2 are separated from one another. First, as illustrated in FIG. 13, the head 2 and the intermediate plate 10 are bonded together by the adhesive 12 to form a head-intermediate plate assembly. Then, as illustrated in FIG. 14, the head-intermediate plate assembly is solder bonded to the gimbal 3a and fixed thereto (in FIG. 14, solder is omitted from illustration). At this time, by the solder that bonds together the electrode pads 10a and the electrode pads 3b, the electrodes 2a of the head 2 are also bonded to the electrode pads 10a, thereby forming a bonding fixation structure as illustrated in FIG. 8. The bonding pads 10c on the back side of the intermediate plate 10 are solder bonded to the electrode pads 3b of the gimbal 3a.

According to the present embodiment, since the intermediate plate 10 having the head 2 (head-intermediate plate assembly) is fixed to the flexure 3 by solder bonding, melting the solder fixing the intermediate plate allows the head 2 to be easily dismounted from the gimbal 3a together with the intermediate plate 10. Therefore, when, after the head has been built in the head assemble, a test is made and the head 2 is determined to be a nonconforming product, there is no need to discard the head assembly in its entirety. That is, by dismounting both the nonconforming head 2 and the intermediate plate 10, and fixing a head-intermediate plate assembly having a new head 2 to the gimbal 3a, it is possible to reuse the flexure 3, the load beam 4, the hinge plate 5, and the base plate 6. This allows a reduction in spoilage cost of the head assembly.

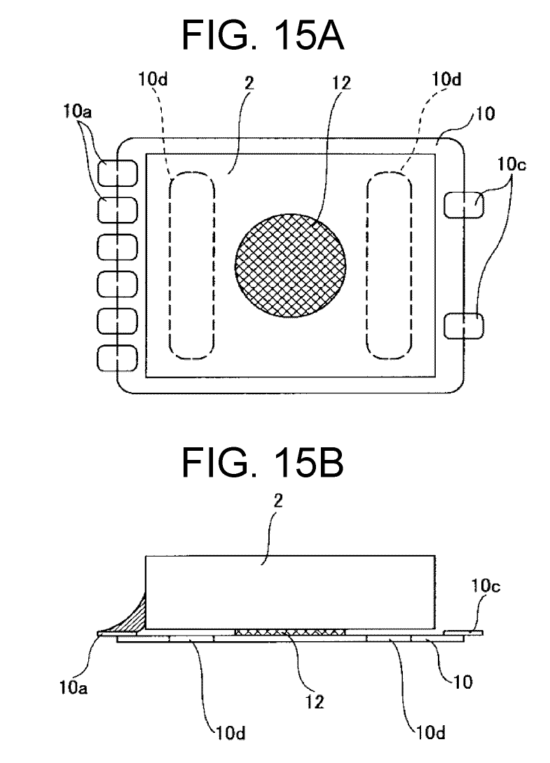

In the present embodiment, because the bonding between the head 2 and the intermediate plate 10 is performed at a center portion of the intermediate plate 10, slits of the intermediate plate 10 may be disposed between the front end and the back end of the intermediate plate 10 to be fixed to the gimbal 3a, and the center portion where the adhesive 12 is disposed. FIGS. 15A and 15B are diagrams of a head-intermediate plate assembly composed of the intermediate plate having the slits and the head, wherein FIG. 15A is a plan view thereof and FIG. 15B is a side view thereof. By arranging the slits, it is possible to make the intermediate plate 10 stretchy, and make it follow the stretch of the gimbal 3a.

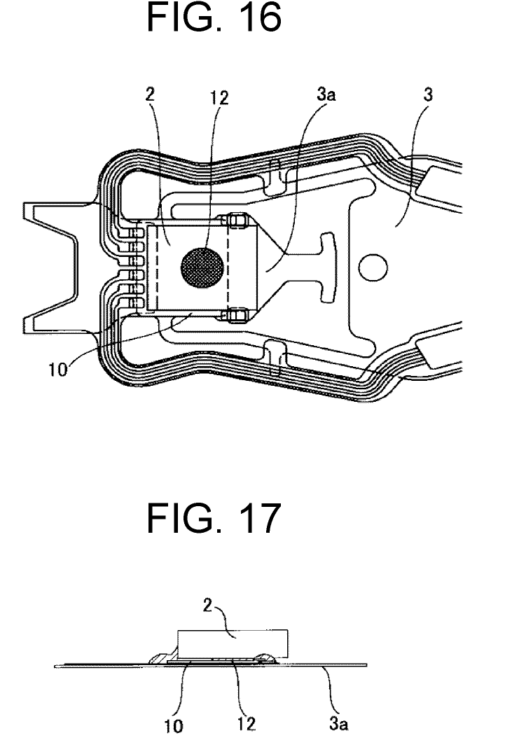

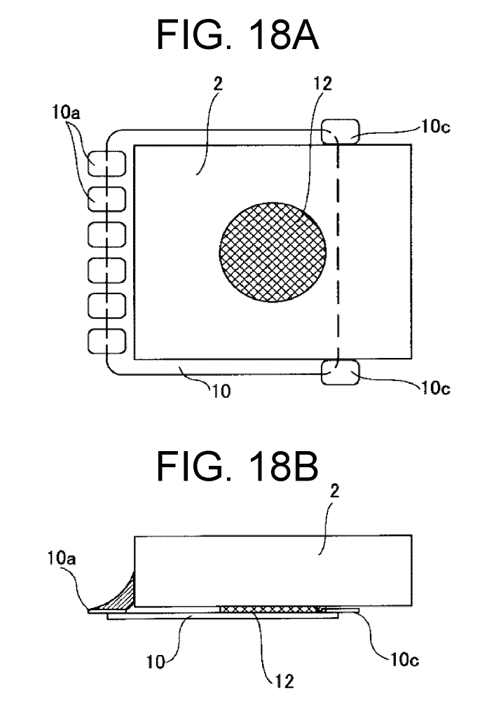

Moreover, by disposing the bonding pads 10c on the back side of the intermediate plate 10 at positions corresponding to a side surface of the head 2, the length of the intermediate plate 10 can be made shorter. FIG. 16 is a plan view of a portion of the head assembly having the intermediate plate 10 of which the bonding pads 10c are disposed at positions corresponding to side surfaces of the head. FIG. 17 is a side view of a portion where the head illustrated in FIG. 16 is fixed. FIGS. 18A and 18B are diagrams of the head-intermediate plate assembly illustrated in FIG. 16, wherein FIG. 18A is a plan view thereof, and FIG. 18B is a side view thereof. The bonding pads 10c are disposed at corner portions of the back end of the intermediate plate 10. Since the positions of the bonding pads 10c are positions corresponding to the side surface of the head 2, the intermediate plate 10 has a shape shorter than the head 2. Therefore, it suffices for the gimbal 3a only to have a size corresponding to the head 2, and so there is no need to increase the size of the gimbal 3a in conformance to the length of the intermediate plate 10.

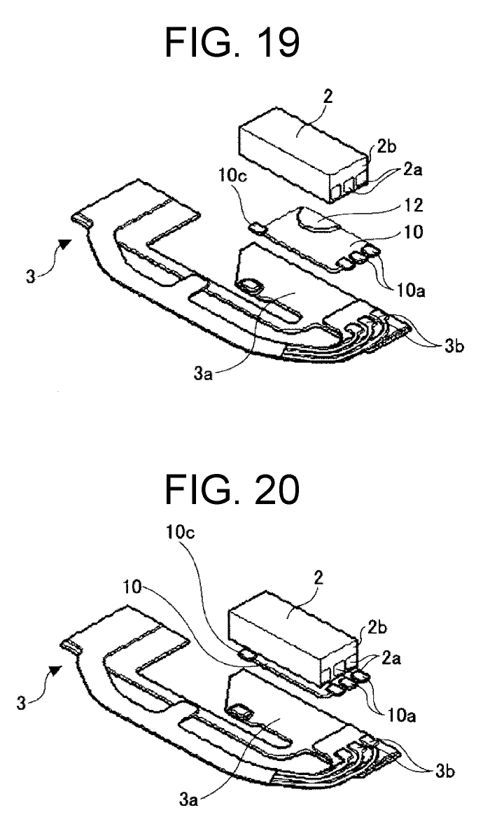

FIGS. 19 to 21 are perspective views of a stack structure composed of the gimbal 3a, the intermediate plate 10, and the head 2. Here, FIGS. 19 to 21 each show only one half side of the flexure 3 divided by the center line thereof.

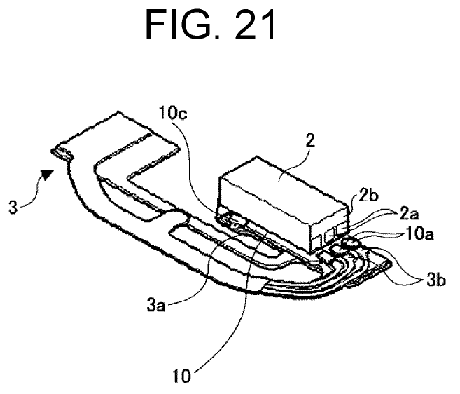

FIG. 19 shows how the gimbal 3a, the intermediate plate 10, and the head 2 are separated from one another. First, as illustrated in FIG. 20, the head 2 and the intermediate plate 10 are bonded together by the adhesive 12 to form a head-intermediate plate assembly. Then, as illustrated in FIG. 21, the head-intermediate plate assembly is solder bonded to the gimbal 3a and fixed thereto (in FIG. 21, solder is omitted from illustration). At this time, by the solder that bonds together the electrode pads 10a and the electrode pads 3b, the electrodes 2a of the head 2 are also bonded to the electrode pads 10a, thereby forming a bonding fixation structure as illustrated in FIG. 8. The bonding pads 10c on the back side of the intermediate plate 10 are solder bonded to the electrode pads 3b of the gimbal 3a.

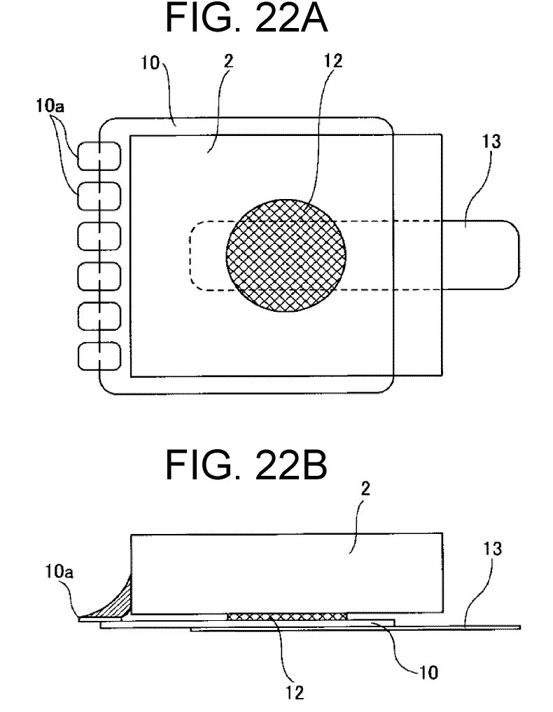

Next, a head assembly according to a third embodiment is described. FIGS. 22A and 22B are diagrams of a head-intermediate plate assembly used in a magnetic head assembly according to the third embodiment; wherein FIG. 22A is a plan view thereof and FIG. 22B is a side view thereof.

In the present embodiment, fixation of the back side of the intermediate plate 10 is performed not by solder bonding by the bonding pads 10c, but by an engaging piece 13 mounted on the intermediate plate 10. The engaging piece 13 is a spring member formed of a comparatively resilient metal plate, such as stainless steel, and mounted on the back surface of the intermediate plate 10 so as to extend backward of the intermediate plate 10. At a position corresponding to the engaging piece 13 of the gimbal 3a, there is provided an opening in which the engaging piece 13 is inserted. By the engaging piece 13 being inserted into this opening of the gimbal 3a to engage with the opening, the intermediate plate 10 is mounted on the gimbal 3a.

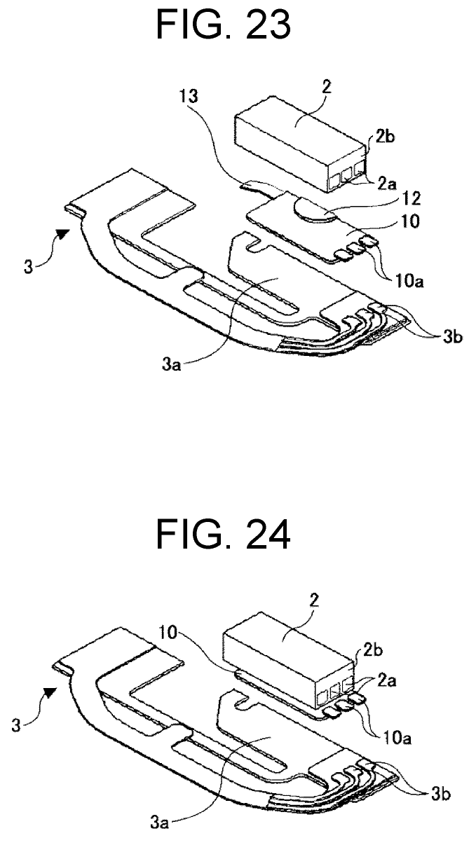

FIGS. 23 to 25 are perspective views of a stack structure composed of the gimbal 3a, the intermediate plate 10, and the head 2. Here, FIGS. 23 to 25 each show only one half side of the flexure 3 divided by the center line thereof.

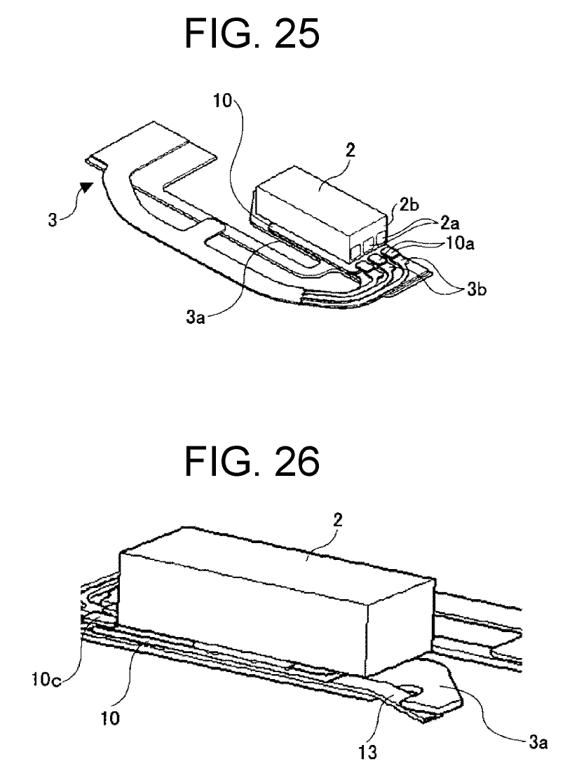

FIG. 23 shows how the gimbal 3a, the intermediate plate 10, and the head 2 are separated from one another. First, as illustrated in FIG. 24, the head 2 and the intermediate plate 10 are bonded together by the adhesive 12 to form a head-intermediate plate assembly. Then, the engaging piece 13 of the head-intermediate plate assembly is inserted into the opening 14 of the gimbal 3a, and as illustrated in FIG. 25, the electrodes 2a of the head 2 is solder bonded to the electrode pads 3b (in FIG. 25, solder is omitted from illustration). As a result, the intermediate plate 10 is fixed to the gimbal 3a.

FIG. 26 is a perspective view of the head-intermediate plate assembly in FIG. 25, as viewed from the back side. FIG. 26 shows how the engaging piece 13 that extends to backward of the intermediate plate 10 has been engagingly inserted into the opening 14 provided in the gimbal 3a. The mechanical connection by the engaging piece 13 and the opening 14 performs a function of fixing the intermediate plate 10 to the gimbal 3a, as in the case of the solder bonding fixation by the bonding pads 10c in the above-described first and second embodiments.

According to the present embodiment, since the intermediate plate 10 having the head 2 (head-intermediate plate assembly) is fixed to the gimbal 3a by solder bonding by the electrode pads 10a and the mechanical connection by the engaging piece 13, the head 2 can be easily dismounted from the gimbal 3a together with intermediate plate 10 by melting the solder fixing the intermediate plate 10. Therefore, when, after the head is built in the head assembly, a test is made and the head 2 is determined to be a nonconforming product, there is no need to discard the head assembly in its entirety. That is, by dismounting both the nonconforming head 2 and the intermediate plate 10, and fixing a head-intermediate plate assembly having a new head 2 to the gimbal 3a, it is possible to reuse the flexure 3, the load beam 4, the hinge plate 5, and the base plate 6. This allows a reduction in spoilage cost of the head assembly.

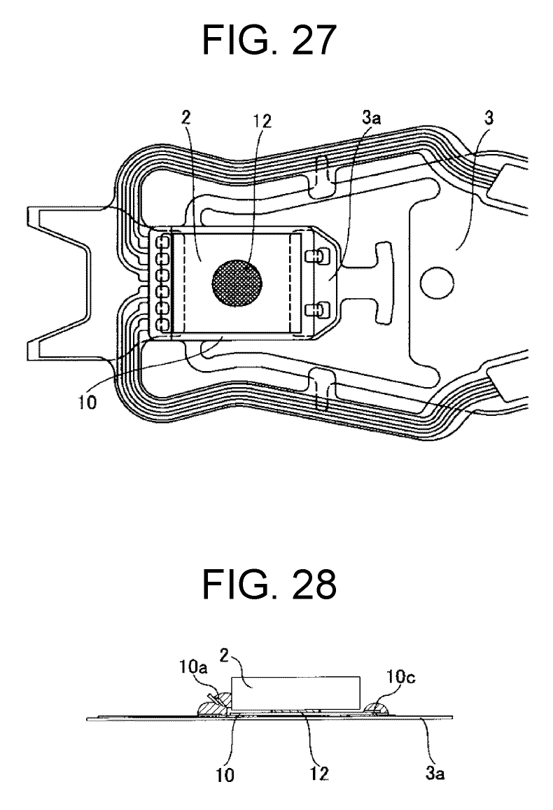

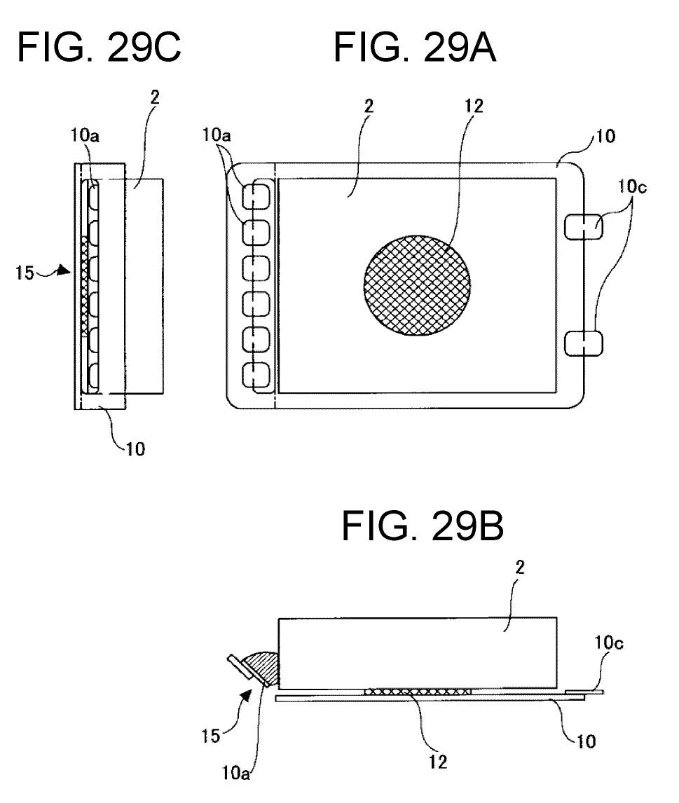

Next, description is made of a modification of solder bonding of the intermediate plate 10 in the above-described embodiments. FIG. 27 is a plan view of a portion of the magnetic head assembly when this modification of solder-bonding is applied to the magnetic head assembly according to the above-described second embodiment. FIG. 28 is a side view of a portion where the head 2 illustrated in FIG. 27 is fixed. FIGS. 29A, 29B, and 29C are diagrams of the head-intermediate plate assembly illustrated in FIG. 27, wherein FIG. 29A is a plan view thereof, FIG. 29B is a side view thereof, and FIG. 29C is a front view thereof.

A portion where the electrode pads 10a are provided on the front side of the intermediate plate 10 is bent to thereby form a slope. In the portion where the electrode pads 10a are provided, there is provided an opening or a notch. The electrode pads 10a are each arranged so that one portion thereof extends into the opening or the notch. The electrode pads 10a are in a state wherein they are opposed to the electrodes 2a of the head 2 while sloping. The electrode pads 3b of the gimbal 3a are disposed so as to be located below the opening/notch 15 of the intermediate plate 10 when the head-intermediate plate assembly is arranged on the gimbal 3a. In this state, when the electrode pads 10a of the intermediate plate 10 and the electrodes 2a of the head 2 are solder bonded together, solder flows, through the opening/notch 15, into the electrode pads 3b, which are located below the opening/notch 15. As a result, via the opening/notch 15, the electrode pads 10a of the intermediate plate 10, the electrodes 2a of the head 2, and the electrode pads 3b of the gimbal 3 are bonded together by soldering.

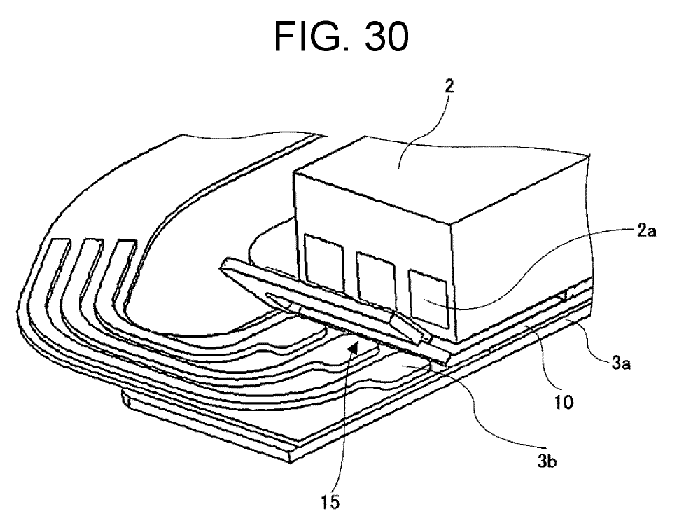

FIG. 30 is a perspective view of a portion where the electrode pads 10a of the intermediate plate 10, the electrodes of the head 2, and the electrode pads 3b of the gimbal 3a are solder bonded. In an example illustrated in FIG. 30, the front side of the intermediate plate 10 is bent by approximately 45 degrees, and the opening/notch 15 is provided in the vicinity of a root part of the bent portion. The electrode pads 3b of the gimbal 3a and the electrodes 2a of the head 2 are arranged at an angle of 90 degrees relative to each other, and the electrode pads 10a of the intermediate plate 10 are arranged therebetween. Since there is provided the notch 15, and the one portion of the electrode pads 10a of the intermediate plate 10 extend into the notch 15, the electrode pads 10a are opposed to the electrode pads 3b of the flexure 3 while being opposed to the electrodes 2a of the head 2. Therefore, the electrode pad 10a of the intermediate plate 10, the electrodes 2a of the head 2, and the electrode pads 3b of the gimbal 3a can be solder bonded together in a small space in an efficient manner. Because the solder-bonded portions are close to one another, not only the solder bonding is easy, but also releasing the bonding by melting the once solidified solder is easy. Therefore, it is also easy to dismount the head-intermediate plate assembly from the gimbal 3a.

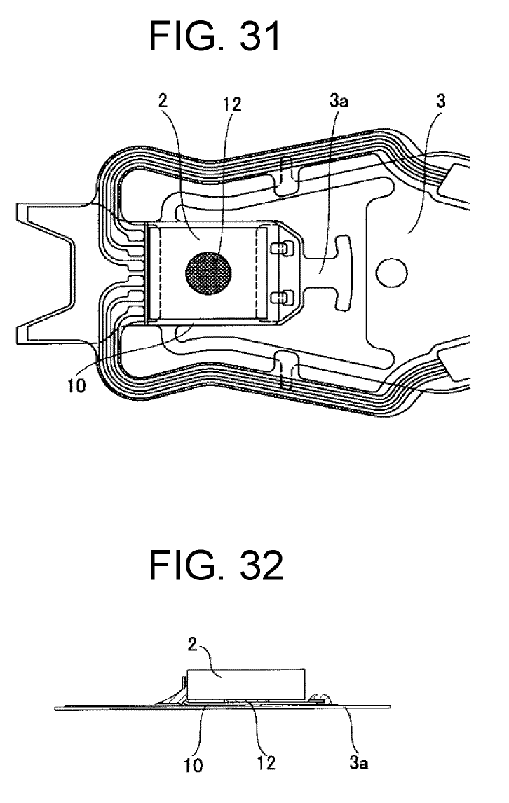

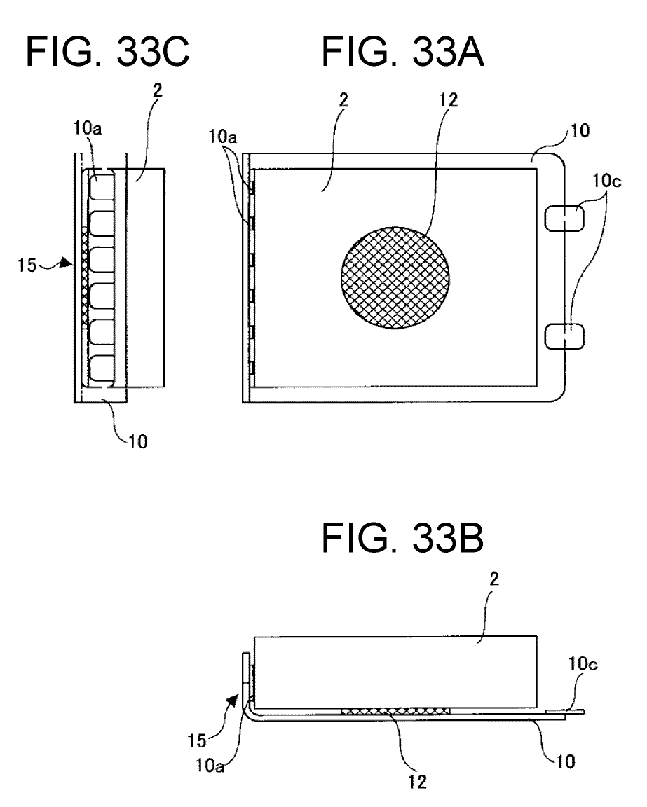

Next, another modification of solder bonding of the intermediate plate 10 in the above-described embodiments is described. FIG. 31 is a plan view of a portion of a magnetic head assembly when another modification of solder-bonding is applied to the magnetic head assembly according to the above-described second embodiment. FIG. 32 is a side view of a portion where a head illustrated in FIG. 31 is fixed. FIGS. 33A, 33B, and 33C are diagrams of a head-intermediate plate assembly illustrated in FIG. 31, wherein FIG. 33A is a plan view thereof, FIG. 33B is a side view thereof, and FIG. 33C is a front view thereof.

A portion where the electrode pads 10a are provided on the front side of the intermediate plate 10 is bent by 90 degrees, and the electrode pads 10a are opposed to the electrodes 2a of the head 2. In the bent portion of the intermediate plate 10, there is provided an opening/notch 15. The electrode pads 10a are arranged so that one portion thereof extends into the opening/notch 15. In a state of the head-intermediate plate assembly illustrated in FIG. 33A to 33C, the electrode pads 10a of the intermediate plate 10 are ultrasonically bonded to the electrodes 2a of the head 2. In order to facilitate the ultrasonic bonding, it is desirable to previously plate the electrode pads 10a and the electrodes 2a with gold (AU). Alternatively, gold bumps or the like may be previously formed on the electrode pads 10a.

The electrode pads 3b of the gimbal 3a are disposed so as to be located below the opening/notch 15 of the intermediate plate 10 when the head-intermediate plate assembly is arranged on the gimbal 3a. In this state, the electrode pads 10a of the intermediate plate 10, exposed to the opening/notch 15 are solder bonded to the electrode pads 3b of the gimbal 3a.

According to the bonding configuration as described above, since the portion where the electrode pads 10a of the intermediate plate 10 is provided becomes a state of being bent along the front side-surface 2b of the head 2, the length of head-intermediate plate assembly is reduced, the area of the gimbal 3a can be decreased correspondingly.

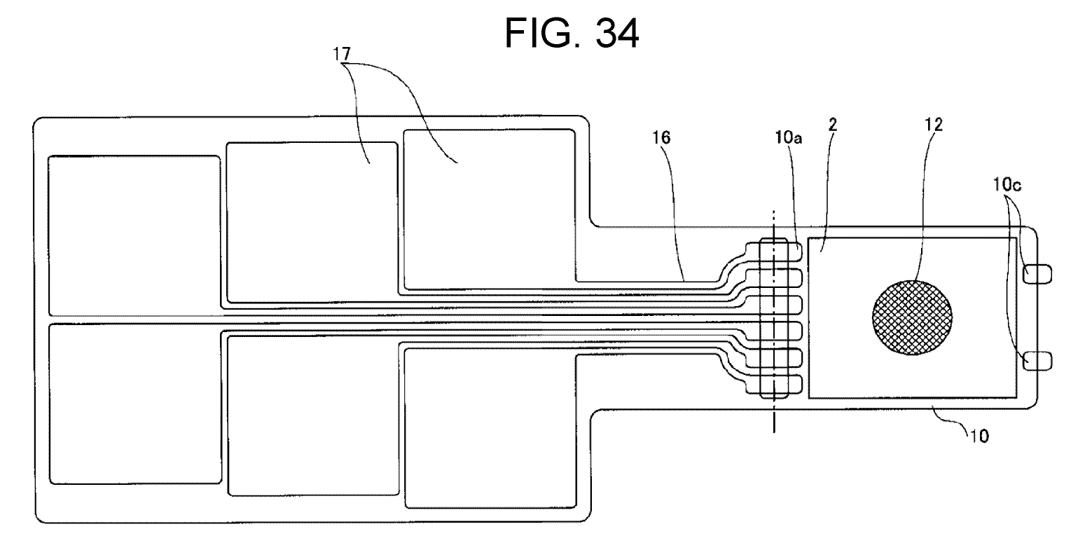

In the above-described embodiments, the magnetic head test is made after the head-intermediate plate assembly has been mounted on the flexure 3 to form a magnetic head assembly. However, the magnetic head test may also be made under conditions of the head-intermediate plate assembly. For this purpose, the intermediate plate is previously arranged to have test electrode pads illustrated in FIG. 34.

In an intermediate plate illustrated in FIG. 34, wiring lines 16 extend from the electrode pads 10a, and test electrode pads 17 are connected to the respective wiring lines 16. By connecting the test electrode pads 17 to a test circuit after the head 2 has been mounted on such an intermediate plate, each electrical test (magnetic head test) of the head 2 is performed. Upon completion of magnetic head tests, each nonconforming head 2 is discarded in a state where it remains fixed to the intermediate plate. On the other hand, in the case of conforming heads, a portion to which each conforming head 2 is bonded and to which the test electrode pads 17 are provided is cut and dismounted. By cutting a portion indicated by a chain line illustrated in FIG. 34, the same shape as that of the intermediate plate 10 used in the above-described embodiments can be obtained.

As described above, since the magnetic head test is performed at the stage of the head-intermediate plate assembly, there is no need for a process to dismount a nonconforming head after having built up the magnetic head assemble, so that the manufacturing process of magnetic head can be simplified. This contributes to a reduction in spoilage cost, resulting in decreased manufacturing cost.

In the above-described embodiment, while descriptions have been made by taking the magnetic head assembly as an example, the present invention is not limited to the magnetic head. The present invention can also be applied to other head assemblies such as an optically-assisted magnetic head or an optical head.

According to the above-described embodiment, the head is easily dismounted from the suspension without deforming the head and the suspension. Therefore, even if the head is found to be nonconforming product after the head assembly has been manufactured, it can be easily dismounted from the head assembly to build-in again a new head. This allows a reduction in cost of spoilage of the head assembly.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A head assembly for writing or reading information to or from a recording medium comprising:
a suspension including an electrode pad;
a mounting member placed on the suspension;
a head mounted on the mounting member and including an electrode, for writing or reading information; and
a first bonding member made of a hot-melt adhesive and fixing the electrode to the electrode pad.

2. The head assembly according to claim 1, wherein the mounting member includes a relay electrode fixed thereto, the first joint fixing the electrode to the relay electrode.

3. The head assembly according to claim 2, wherein the electrode is disposed on one of side surfaces of the head, and the relay electrode pad is disposed at a position adjacent to the one side surface of the head.

4. The head assembly according to claim 2, wherein the mounting member includes a first bonding pad fixed thereto, and the suspension includes a second boding pad fixed thereto, the first bonding pad is fixed to the second bonding pad by a hot-melt adhesive.

5. The head assembly according to claim 1, wherein the Young's modulus of the mounting member is lower than that of the suspension.

6. The head assembly according to claim 5, wherein the Young's modulus of the mounting member is lower than that of the head.

7. The head assembly according to claim 6, wherein the material of the mounting member has a linear expansion coefficient higher than those of the material of the head and the material of the suspension.

8. The head assembly according to claim 1, wherein the hot-melt adhesive is solder.

9. The head assembly according to claim 1, wherein the mounting member includes a third bonding pad fixed thereto, and the head includes a fourth boding pad fixed thereto, the fourth bonding pad is fixed to the third bonding pad by a hot-melt adhesive.

10. The head assembly according to claim 1, further comprising second bonding member made of an adhesive fixing the head to the mounting member.

11. The head assembly according to claim 10, wherein the adhesive is an ultraviolet curable adhesive.

12. The head assembly according to claim 1, further comprising a mechanical connection fixing the head to the mounting member.

13. The head assembly according to claim 12, wherein the mechanical connection comprises:
an opening provided in the suspension; and
a leaf spring member provided to the mounting member, adapted to engage with the opening.

14. The head assembly according to claim 1, wherein the mounting member includes a slit for making the member stretchy.

15. The head assembly according to claim 10, wherein the second bonding member is disposed on a portion of the mounting member, the mounting member further includes a slit for making the mounting member stretchy, the slit being disposed at another portion of the mounting member.

16. The head assembly according to claim 2, wherein one end of the mounting member is bent to thereby form a slope, the mounting member includes an opening or a notch in the bent portion, and the relay electrode pad is arranged so that one portion thereof extends to the opening or the notch.

17. The head assembly according to claim 2, wherein one end of the mounting member is bent by approximately 90 degrees, the mounting member includes an opening or a notch in the bent portion, the relay electrode pad is arranged so that one portion thereof extends to the opening or the notch, and the relay electrode pad is ultrasonically bonded to the electrode of the head.

18. The head assembly according to claims 1, wherein the mounting member includes a test electrode pad connected to the relay electrode pad, and the head assembly is formed in such a way that the head is fixed to the mounting member, and then after an electrical test of the head has been performed via the test electrode pad, the test electrode pad is dismounted.

19. A disk device comprising:
a recording medium for recording information; and
a head assembly including:
a suspension including an electrode pad,
a mounting member placed on the suspension,
a head mounted on the mounting member and including an electrode, for writing or reading information on or from the recording medium, and
a first bonding member made of a hot-melt adhesive, fixing the electrode to the electrode pad.
